(19) United States
(12) Patent Application Publication
(10) Pub. No.: US 2010/0118238 A1
(43) Pub. Date: May 13, 2010

(54) LIQUID CRYSTAL DISPLAY DEVICE

(76) Inventors: Junya Shimada, Osaka (JP); Hajime Imai, Osaka (JP); Tetsuo Kikuchi, Osaka (JP); Hideki Kitagawa, Osaka (JP); Mitsunori Imade, Osaka (JP); Yoshihito Hara, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/524,914

(22) PCT Filed: Dec. 10, 2007
(86) PCT No.: PCT/JP2007/073787

§ 371 Date: Jul. 29, 2009

(30) Foreign Application Priority Data
Jan. 31, 2007 (JP) 2007-021200

(51) Int. Cl. G02F 1/1335

(52) U.S. Cl. 349/113

(57) ABSTRACT

Reflection-type and transflective-type liquid crystal display devices having a high image quality, in which moiré or coloration is reduced, are provided at low cost.

A liquid crystal display device according to the present invention is a liquid crystal display device having a reflection region in each of a plurality of pixels; the reflection region includes a metal layer, a semiconductor layer, and a reflective layer; a plurality of recesses and protrusions are formed on the surface of the reflective layer; the plurality of recesses are formed according to apertures in the metal layer; the plurality of protrusions are formed so as to conform to the shape of the semiconductor layer; a plurality of pairs among the plurality of recesses that adjoin along a direction include two pairs whose intervals between recesses are different from each other; and a plurality of pairs among the plurality of protrusions that adjoin along a direction include two pairs whose intervals between protrusions are different from each other.

### TECHNICAL FIELD

The present invention relates to a reflection-type or transflective-type liquid crystal display device capable of performing display by utilizing reflected light.

### BACKGROUND ART

Liquid crystal display devices (LCDs) include the transmission-type liquid crystal display device which utilizes backlight from behind the display panel as a light source for displaying, the reflection-type liquid crystal display device which utilizes reflected light of external light, and the transflective-type liquid crystal display device (reflection/transmission-type liquid crystal display device) which utilizes both reflected light of external light and backlight. The reflection-type liquid crystal display device and the transflective-type liquid crystal display device are characterized in that they have smaller power consumptions than that of the transmission-type liquid crystal display device, and their displayed images are easy to see in a bright place. The transflective-type liquid crystal display device is characterized in that its screen is easier to see than that of the reflection-type liquid crystal display device, even in a dark place.

FIG. 10 is a cross-sectional view showing an active matrix substrate 100 in a conventional reflection-type liquid crystal display device (e.g., Patent Document 1).

As shown in this figure, the active matrix substrate 100 includes an insulative substrate 101, as well as a gate layer 102, a gate insulating layer 104, a semiconductor layer 106, a metal layer 108, and a reflective layer 110, which are stacked on the insulative substrate 101. After being stacked on the insulative substrate 101, the gate layer 102, the gate insulating layer 104, the semiconductor layer 106, and the metal layer 108 are subjected to etching by using one mask, thus being formed so as to have an island-like multilayer structure. Thereafter, the reflective layer 110 is formed on this multilayer structure, whereby a reflection surface 112 having ruggednesses is formed. Although not shown, transparent electrodes, a liquid crystal layer, a color filter substrate (CF substrate), and the like are stacked above the active matrix substrate 100.

FIG. 11 is a cross-sectional view of a conventional transflective-type liquid crystal display device (e.g., Patent Document 2).

As shown in this figure, in the conventional transflective-type liquid crystal display device, an interlayer insulating film 204 is formed on a drain electrode 222 of a switching element (TFT) 203, and a galvanic corrosion preventing film 205, a reflection electrode film 206, and an amorphous transparent electrode film 218 are stacked on the interlayer insulating film 204. The region where the reflection electrode film 206 is formed is a reflection region of the transflective-type liquid crystal display device. Ruggednesses are formed in an upper portion of the interlayer insulating film 204 within the reflection region, and conforming to these ruggednesses, ruggednesses are also formed on the galvanic corrosion preventing film 205, the reflection electrode film 206, and the amorphous transparent electrode film 218.

Moreover, in the case where ruggednesses are repeatedly disposed on a reflective layer at a uniform interval, a diffraction pattern (moiré) or coloration may occur in the reflected light due to interference of light. Patent Document 3 describes a liquid crystal display device in which some of the ruggednesses are disposed irregularly in order to suppress occurrence of such a diffraction pattern or the like.

[Patent Document 1] Japanese Laid-Open Patent Publication No. 9-54318

[Patent Document 2] Japanese Laid-Open Patent Publication No. 2005-277402

[Patent Document 3] Japanese Laid-Open Patent Publication No. 2002-14211

### DISCLOSURE OF INVENTION

### Problems to be Solved by the Invention

In the active matrix substrate 100 described in Patent Document 1, portions of the reflective layer 110 are formed so as to reach the insulative substrate 101 in portions where the gate layer 102 and the like are not formed (i.e., portions between the islands, hereinafter referred to as “gap portions”). Therefore, in the gap portions, the surface of the reflection surface 112 is recessed in the direction of the insulative substrate 101, thus forming a plane having deep dents (or recesses).

In the reflection-type liquid crystal display device or the transflective-type liquid crystal display device, in order to perform bright display with a wide viewing angle, it is necessary to allow incident light entering the display device to be more uniformly and efficiently reflected by the reflection surface 112 across the entire display surface, without causing specular reflection in one direction. For this purpose, it is better if the reflection surface 112 has moderate ruggednesses rather than being a complete plane.

However, the reflection surface 112 of the aforementioned active matrix substrate 100 has deep dents. Therefore, light is unlikely to reach the reflection surface located in lower portions of the dents, and even if at all light reaches there, the reflected light thereof is unlikely to be reflected toward the liquid crystal layer, thus resulting in a problem in that the reflected light is not effectively utilized for displaying. Furthermore, many portions of the reflection surface 112 have a large angle with respect to the display surface of the liquid crystal display device, thus resulting in a problem in that so that the reflected light from those portions is not effectively utilized for displaying.

FIG. 12 is a diagram showing a relationship between the tilt of the reflection surface 112 and reflected light. FIG. 12(a) shows a relationship between an incident angle a and an outgoing angle β when light enters a medium b having a refractive index Nb from a medium a having a refractive index Na. In this case, according to Snell's Law, the following relationship holds true.

Na×sin α=Nb×sin β

FIG. 12(b) is a diagram showing a relationship between incident light and reflected light when incident light perpendicularly entering the display surface of a liquid crystal display device is reflected from a reflection surface which is tilted by θ with respect to the display surface (or the substrate). As shown in the figure, the incident light perpendicularly entering the display surface is reflected from the reflection surface which is tilted by angle θ with respect to the display surface, and goes out in a direction of an outgoing angle φ.

Results of calculating the outgoing angle φ according to Snell's Law with respect to each angle θ of the reflection surface are shown in Table 1.

TABLE 1

| θ | φ | 90 − φ |
|---|---|---|
| 0 | 0 | 90 |
| 2 | 6.006121 | 83.99388 |
| 4 | 12.04967 | 77.95033 |
| 6 | 18.17181 | 71.82819 |
| 8 | 24.42212 | 65.57788 |
| 10 | 30.86588 | 59.13412 |
| 12 | 37.59709 | 52.40291 |
| 14 | 44.76554 | 45.23446 |
| 16 | 52.64382 | 37.35618 |
| 18 | 61.84543 | 28.15457 |
| 20 | 74.61857 | 15.38143 |
| 20.5 | 79.76542 | 10.23458 |
| 20.6 | 81.12757 | 8.872432 |
| 20.7 | 82.73315 | 7.266848 |
| 20.8 | 84.80311 | 5.19888 |
| 20.9 | 88.85036 | 1.149637 |
| 20.905 | 89.79914 | 0.200856 |

The values in this Table are calculated by assuming that air has a refractive index of 1.0 and the glass substrate and the liquid crystal layer have a refractive index of 1.5. As shown in Table 1, when the angle θ of the reflection surface exceeds 20 degrees, the outgoing angle φ becomes very large (i.e., 90-φ becomes very small), so that most of the outgoing light does not reach the user. Therefore, even if ruggednesses are provided on the reflection surface of the reflective layer, in order to effectively utilize reflected light, it must be ensured in more portions of the reflection surface that the angle θ is 20 degrees or less.

Since the reflection surface 112 of the aforementioned active matrix substrate 100 has many portions which are greater than 20 degrees, reflected light is not very effectively used for displaying. In order to solve this problem, it might be possible to form an insulating layer under the reflective layer 110 and form the reflective layer 110 upon this insulating layer. However, in this case, a step of forming an insulating layer and a step of forming contact holes for connecting the reflective layer 110 to the drains of the TFTs in the insulating layer are needed, thus resulting in a problem of an increase in the material and the number of steps.

Moreover, in the transflective-type liquid crystal display device of Patent Document 2, after stacking the interlayer insulating film 204 on the drain electrode 222, a step of forming ruggednesses in an upper portion thereof is needed, and a step of stacking the galvanic corrosion preventing film 205, the reflection electrode film 206, and the amorphous transparent electrode film 218 further thereupon is needed. Thus, the conventional transflective-type liquid crystal display device also has a problem in that the material and number of steps are increased for forming the reflection region.

Furthermore, in a conventional transflective-type liquid crystal display device, ruggednesses are formed on the surface of the amorphous transparent electrode film 218, which is in contact with the liquid crystal layer 211, and therefore the electric field which is formed across the liquid crystal layer 211 is not uniform, thus making it difficult to uniformly control the liquid crystal orientation in a desired direction in the reflection region. Moreover, although a slope which conforms to the end shape of the interlayer insulating film 204 is formed at an end of the amorphous transparent electrode film 218, there is also a problem in that this slope disturbs the orientation of the liquid crystal near the end of the reflection region.

In the liquid crystal display device of Patent Document 3, ruggednesses are formed by photolithography technique on a photosensitive resin layer which is formed over switching elements, and thereafter a reflective layer is formed on the ruggednesses. Therefore, in this liquid crystal display device, too, problems similar to those of the transflective-type liquid crystal display device of Patent Document 2 described above will occur.

The present invention has been made in view of the above problems, and an objective thereof is to provide at low cost reflection-type and transflective-type liquid crystal display devices having a high image quality, in which moiré or coloration due to interference of reflected light and the like is reduced.

### Means for Solving the Problems

A liquid crystal display device according to the present invention is a liquid crystal display device having a plurality of pixels, and comprising, in each of the plurality of pixels, a reflection region for reflecting incident light toward a display surface, wherein, the reflection region includes a metal layer, a semiconductor layer formed on the metal layer, and a reflective layer formed on the semiconductor layer; a plurality of first recesses or protrusions and a plurality of second recesses or protrusions are formed on a surface of the reflective layer; the plurality of first recesses or protrusions are formed so as to conform to the shapes of recesses (including apertures) or protrusions of the metal layer, and the plurality of second recesses or protrusions are formed so as to conform to the shapes of recesses (including apertures) or protrusions of the semiconductor layer; and the plurality of first recesses or protrusions have a plurality of first pairs of first recesses or protrusions adjoining along a first direction, the plurality of first pairs including two pairs whose intervals between recesses or protrusions are different from each other, or the plurality of second recesses or protrusions have a plurality of second pairs of second recesses or protrusions adjoining along a second direction, the plurality of second pairs including two pairs whose intervals between recesses or protrusions are different from each other.

In one embodiment, the plurality of first recesses or protrusions have a plurality of third pairs of first recesses or protrusions adjoining along a third direction which is different from the first direction, and the plurality of third pairs include two pairs whose intervals between recesses or protrusions are different from each other.

In one embodiment, the plurality of second recesses or protrusions have a plurality of fourth pairs of second recesses or protrusions adjoining along a fourth direction which is different from the second direction, and the plurality of fourth pairs include two pairs whose intervals between recesses or protrusions are different from each other.

In one embodiment, the plurality of first recesses or protrusions have a plurality of third pairs of first recesses or protrusions adjoining along a third direction which is different from the first direction, and the plurality of third pairs include two pairs whose intervals between recesses or protrusions are different from each other; and the plurality of second recesses or protrusions have a plurality of fourth pairs of second recesses or protrusions adjoining along a fourth direction which is different from the second direction, and the plurality of fourth pairs include two pairs whose intervals between recesses or protrusions are different from each other.

In one embodiment, on the surface of the reflective layer, at least either the plurality of first recesses or protrusions or the plurality of second recesses or protrusions are randomly disposed.

In one embodiment, on the surface of the reflective layer, both the plurality of first recesses or protrusions and the plurality of second recesses or protrusions are randomly disposed.

One embodiment comprises a semiconductor element provided corresponding to each of the plurality of pixels, wherein, the metal layer, the semiconductor layer, and the reflective layer are made of same materials as those of a gate electrode, a semiconductor portion, and source and drain electrodes of the semiconductor element, respectively.

One embodiment comprises a liquid crystal layer and an interlayer insulating layer and a pixel electrode interposed between the liquid crystal layer and the reflective layer, wherein a surface of the pixel electrode facing the liquid crystal layer is formed flat without conforming to shapes of the first recesses or protrusions and the second recesses or protrusions of the reflective layer.

### Effects of the Invention

According to the present invention, reflection-type and transflective-type liquid crystal display devices having a high image quality, in which moiré or coloration due to interference of reflected light and the like is reduced, can be provided at low cost.

### BRIEF DESCRIPTION OF DRAWINGS

FIG. 1 A diagram schematically showing a cross-sectional shape of a liquid crystal display device according to Embodiment 1.

FIG. 2 Plan views showing a liquid crystal display device of Embodiment 1, where (a) shows the construction of a pixel region, and (b) shows the construction of a reflection section.

FIG. 3 Cross-sectional views showing the construction of a TFT section and a reflection section of Embodiment 1, where (a) shows the construction of a reflection section, and (b) shows the construction of a TFT section.

FIG. 4 A schematic diagram for comparison of a liquid crystal display device of Embodiment 1 and a conventional liquid crystal display device with respect to their reflection section constructions, where (a) is a diagram showing a cross section of a reflection section of Embodiment 1, (b) is a diagram showing a cross section of a reflection section of a conventional liquid crystal display device, and (c) is a diagram describing surface angles at a corner portion of the reflection section.

FIG. 5 Plan views showing a production method for a reflection section of Embodiment 1.

FIG. 6 Cross-sectional views showing a production method for a reflection section of Embodiment 1.

FIG. 7 A plan view showing a reflection section of a liquid crystal display device according to Embodiment 2.

FIG. 8 A plan view showing a reflection section of a liquid crystal display device according to Embodiment 3.

FIG. 9 A cross-sectional view showing a liquid crystal display device according to Embodiment 4.

FIG. 10 A cross-sectional view showing an active matrix substrate of a conventional reflection-type liquid crystal display device.

FIG. 11 A cross-sectional view of a conventional transflective-type liquid crystal display device.

FIG. 12 A diagram showing a relationship between a tilt of a reflection surface and reflected light in a liquid crystal display device, where (a) shows a relationship between an incident angle α and an outgoing angle β when light enters a medium b having a refractive index Nb from a medium a having a refractive index Na, and (b) is a diagram showing a relationship between incident light and reflected light as well as the angle of the display surface of the liquid crystal display device.

### DESCRIPTION OF REFERENCE NUMERALS

10 liquid crystal display device
12 TFT substrate
14 counter substrate
16 liquid crystal
18 liquid crystal layer
22 transparent substrate
26 interlayer insulating layer
28 pixel electrode
30 reflection section
31 layer
32 TFT section
34 counter electrode
36 CF layer
38 transparent substrate
40 display surface
42 reflection region
44 TFT region
46 transmission region
50 pixel
52 source line
54 gate line
56 Cs metal layer
58 contact hole
61 gate insulating layer
62 semiconductor layer
63 reflective layer
65 aperture
67 protrusion
68, 69 recess
100 active matrix substrate
101 insulative substrate
102 gate layer
104 gate insulating layer
106 semiconductor layer
108 metal layer
110 reflective layer
112 reflection surface
203 switching element
204 interlayer insulating film
205 galvanic corrosion preventing film
206 reflection electrode film
211 liquid crystal layer
218 amorphous transparent electrode film
222 drain electrode

### BEST MODE FOR CARRYING OUT THE INVENTION

### Embodiment 1

Hereinafter, with reference to the drawings, a first embodiment of the liquid crystal display device according to the present invention will be described.

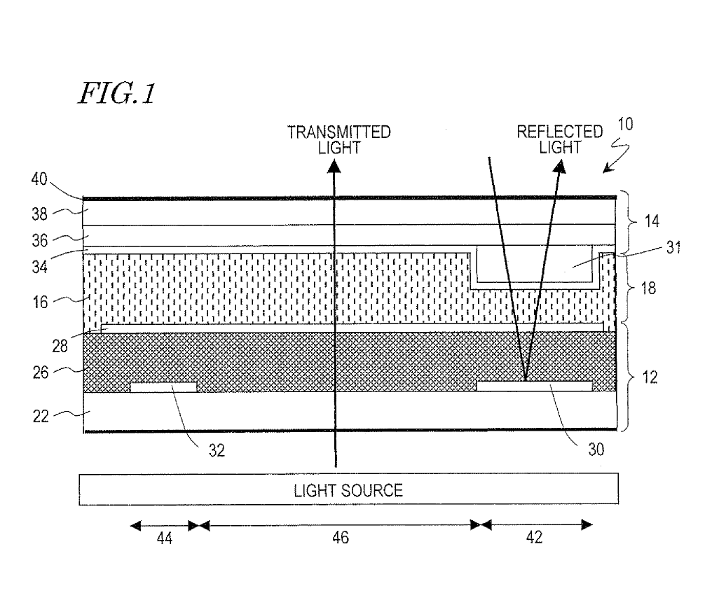

FIG. 1 is a diagram schematically showing a cross-sectional shape of a liquid crystal display device 10 of the present embodiment. The liquid crystal display device 10 is a transflective-type liquid crystal display device (LCD) by an active matrix method. As shown in FIG. 1, the liquid crystal display device 10 includes a TFT (Thin Film Transistor) substrate 12, a counter substrate 14 such as a color filter substrate (CF substrate), and a liquid crystal layer 18 containing liquid crystal 16 which is sealed between the TFT substrate 12 and the counter substrate 14.

The TFT substrate 12 includes a transparent substrate 22, an interlayer insulating layer 26, and a pixel electrode 28, and includes reflection sections 30 and TFT sections 32. Note that gate lines (scanning lines), source lines (signal lines), Cs lines (storage capacitor electrode lines), and the like are also formed on the TFT substrate 12, which will be described later.

The counter substrate 14 includes a counter electrode 34, a color filter layer (CF layer) 36, and a transparent substrate 38. The upper face of the transparent substrate 38 serves as a display surface 40 of the liquid crystal display device. Note that although the TFT substrate 12 and the counter substrate 14 each have an alignment film and a polarizer, they are omitted from the figure.

In the liquid crystal display device 10, a region where a reflection section 30 is formed is referred to as a reflection region 42, whereas a region where a TFT section 32 is formed is referred to as a TFT region 44. In the reflection region, light entering from the display surface 40 is reflected by the reflection section 30, and travels through the liquid crystal layer 18 and the counter substrate 14 so as to go out from the display surface 40. Furthermore, the liquid crystal display device 10 has transmission regions which are formed in regions other than the reflection regions 42 and the TFT regions 44. In the transmission regions 46, light which is emitted from a light source in the liquid crystal display device 10 travels through the TFT substrate 12, the liquid crystal layer 18, and the counter substrate 14 so as to go out from the display surface 40.

Note that, by providing a layer 31 made of transmissive resin or the like on the counter substrate 14 side above each reflection section 30 as shown in FIG. 1, it is possible to reduce the thickness of the liquid crystal layer 18 in the reflection region 42 to a half of the thickness of the liquid crystal layer 18 in the transmission region 46. As a result, the optical path length can be made equal between the reflection region 42 and the transmission region 46. Although FIG. 1 illustrates the layer 31 as being formed between the counter electrode 34 and the CF layer 36, the layer 31 may be formed on the face of the counter electrode 34 facing the liquid crystal layer 18.

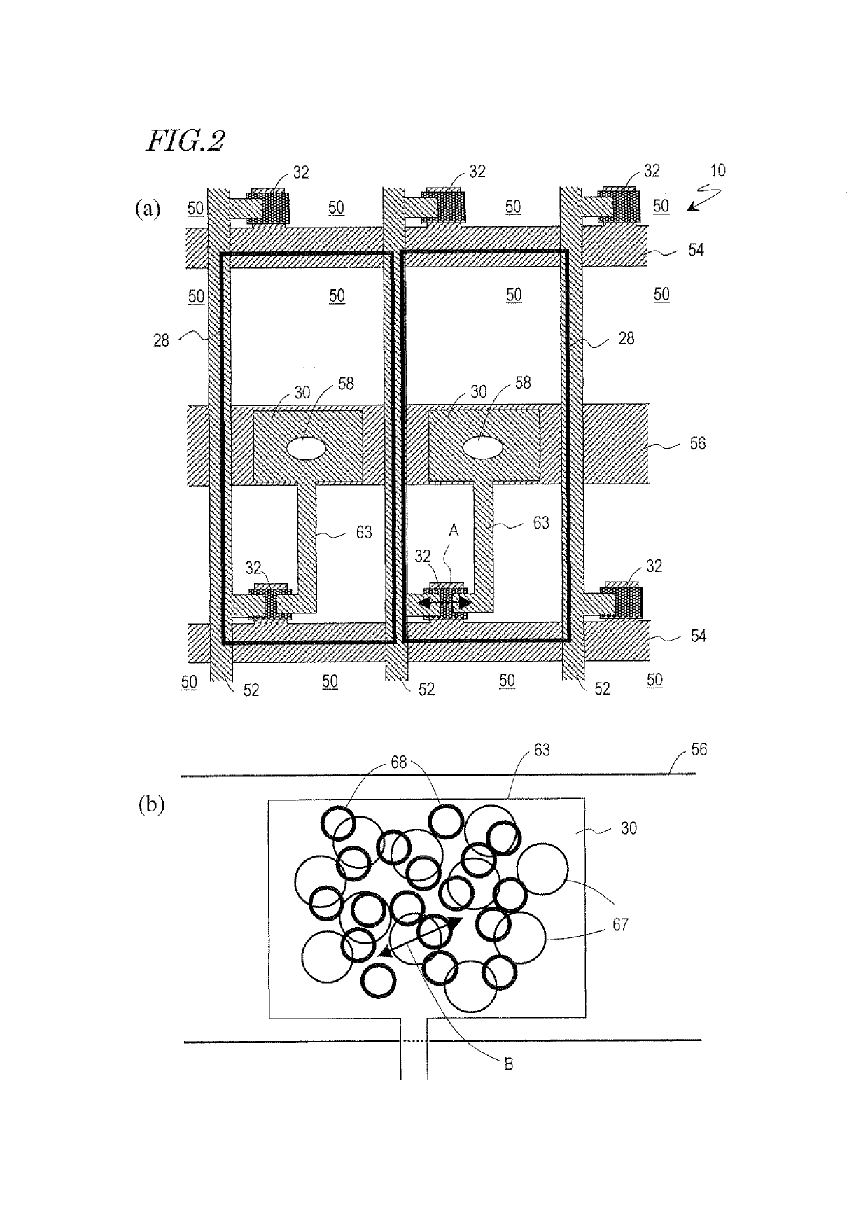

FIG. 2 is plan views more specifically showing the construction of the pixel regions and the reflection sections 30 of the liquid crystal display device 10.

FIG. 2(a) is a plan view of a portion of the liquid crystal display device 10, as seen from above the display surface 40. As shown in the figure, a plurality of pixels 50 are disposed in a matrix shape in the liquid crystal display device 10. The aforementioned reflection section 30 and TFT section 32 are formed in each pixel 50, with a TFT being formed in the TFT section 32.

In the border of the pixel 50, source lines 52 extend along the column direction (up-down direction in the figure), and gate lines (also referred to as gate metal layers) 54 extend along the row direction (right-left direction in the figure). In the central portion of the pixel 50, a Cs line 56 (Cs metal layer or metal layer 56) extends along the row direction. In the interlayer insulating layer 26 of the reflection region 30, a contact hole 58 for connecting the pixel electrode 28 and the drain electrode of the TFT is formed.

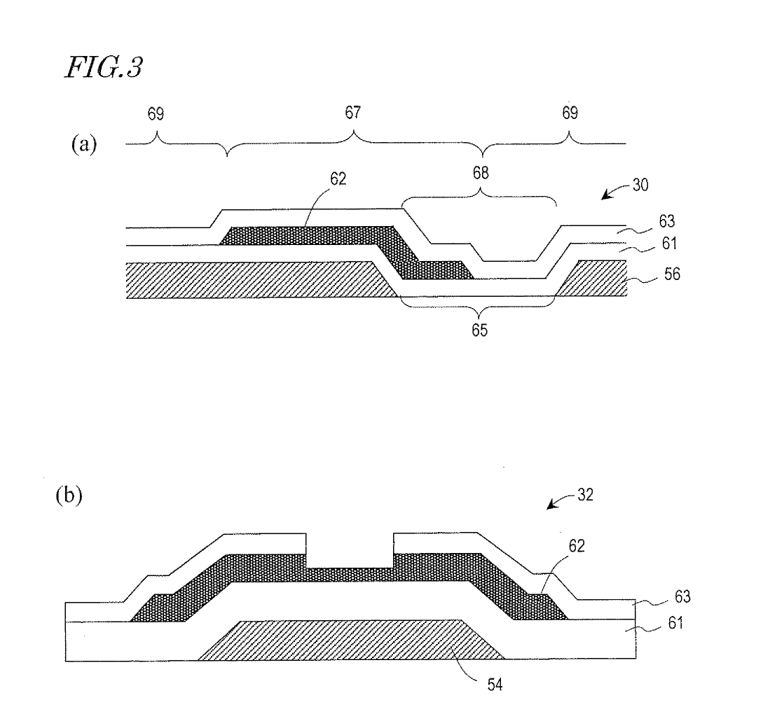

FIG. 2(b) is a plan view schematically showing the construction of the reflection section 30 above the Cs metal layer 56. In this figure, the contact hole 58 is omitted from illustration. As will be described later with reference to FIG. 3, the reflection section 30 includes a gate insulating layer 61 formed on the Cs metal layer 56, a semiconductor layer 62 formed on the gate insulating layer 61, and a reflective layer 63 formed on the semiconductor layer 62.

As shown in the figure, a plurality of protrusions and recesses 68 are provided on the surface of the reflective layer 63. Although 18 recesses 68 and 11 protrusions 67 are illustrated herein for ease of understanding the construction, more recesses 68 may actually be formed. The plurality of recesses 68 are formed so as to conform to the shapes of the apertures (or recesses) 65 in the Cs metal layer 56, whereas the protrusion 67 are formed so as to conform to the shapes of the semiconductor layer 62, which is formed in island shapes.

The Cs metal layer 56 may be formed in island shapes, and protrusions may be formed so as to conform to their shapes, instead of apertures (or recesses) 65. Apertures (or recesses) may be formed in a semiconductor layer 62 which is formed so as to cover the reflection section 30, and recesses may be formed so as to conform to their shapes, instead of protrusions 67. In the present specification, any recess 68 or a protrusion replacing it will be referred to as a first recess or protrusion, and any protrusion 67 or a recess replacing it will be referred to as a second recess or protrusion.

The recesses 68 (or first recesses or protrusions) and the protrusions 67 (or second recesses or protrusions) are both randomly disposed. However, the protrusions 67 and the recesses 68 do not need to be perfectly randomly disposed, but may be randomly disposed in portions of the surface of the reflective layer 63. Moreover, a layout lacking symmetry or an anisotropic layout may be adopted.

In either case, a plurality of pairs (first pairs) of recesses 68 adjoining along a direction (first direction) include two pairs whose intervals between recesses 68 are different from each other. Moreover, a plurality of pairs (second pairs) of protrusions 67 adjoining along a direction (second direction) include two pairs whose intervals between protrusions 67 are different from each other.

Moreover, a plurality of pairs (third pairs) of recesses 68 adjoining along a direction (third direction) which is different from the first direction may include two pairs whose intervals between recesses 68 are different from each other, and a plurality of pairs (fourth pairs) of protrusions 67 adjoining along a direction (fourth direction) which is different from the second direction may include two pairs whose intervals between protrusions 67 are different from each other. With such layout methods, it becomes possible to reduce occurrence of moiré or coloration due to interference of reflected light.

Next, with reference to FIG. 3, the construction of the reflection section 30 and the TFT section 32 will be described more specifically.

FIG. 3(a) shows a cross section of the reflection section 30 (a cross section of a portion shown by arrow B in FIG. 2(b)). As shown in the figure, in the reflection section 30, the Cs metal layer (metal layer) 56, the gate insulating layer (insulating layer) 61, the semiconductor layer 62, and the reflective layer 63 are stacked. The semiconductor layer 62 is composed of an intrinsic amorphous silicon layer (Si(i) layer) and an n+ amorphous silicon layer (Si(n+) layer) which is doped with phosphorus, for example.

The Cs metal layer 56 has an aperture 65, such that a portion of the semiconductor layer 62, which is formed in an island shape, is located inside the aperture 65. A recess 68 is formed on the surface of the reflective layer 63 above the aperture 65, whereas a protrusion 67 is formed on the surface of the reflective layer 63 above the semiconductor layer 62. Moreover, the portion of the surface of the reflective layer 63 where no underlying semiconductor layer is formed becomes a recess 69. Level differences are formed in the reflective layer 63 on the semiconductor layer 62 inside the recess 68.

The recess 68 is formed by the gate insulating layer 61, the semiconductor layer 62, and the reflective layer 63 being formed above the aperture 65 of the Cs metal layer 56, whereby the reflective layer 63 becomes dented. On the other hand, the protrusion 67 is created by the reflective layer 63 being formed on the semiconductor layer 62, whereby the reflective layer 63 protrudes. Note that, a recess (dent) may be formed in the Cs metal layer 56, instead of an aperture 65. In that case, the recess 68 is to be formed in accordance with that recess of the Cs metal layer.

By adding a level difference to the side face of the aperture 65 of the Cs metal layer 56, a level difference may be introduced to the slope of the recess 68. Moreover, by adding a level difference to the side face of the semiconductor layer 62, a level difference may be introduced to the slope of the protrusion 67.

FIG. 3(b) is a diagram showing the construction of the gate metal layer (metal layer) 54, the gate insulating layer 61, the semiconductor layer 62, and the reflective layer 63 in the TFT section 32, and is a cross-sectional view of a portion at arrow A in FIG. 2(a). The gate metal layer 54 in the TFT section 32 is formed concurrently with and from the same member as the Cs metal layer 56 in the reflection section 30. Similarly, the gate insulating layer 61, the semiconductor layer 62, and the reflective layer 63 in the TFT section 32 are formed concurrently with and from the same members as, respectively, the gate insulating layer 61, the semiconductor layer 62, and the reflective layer 63 in the reflection section 30. The reflective layer 63 is connected to the drain electrode of the TFT.

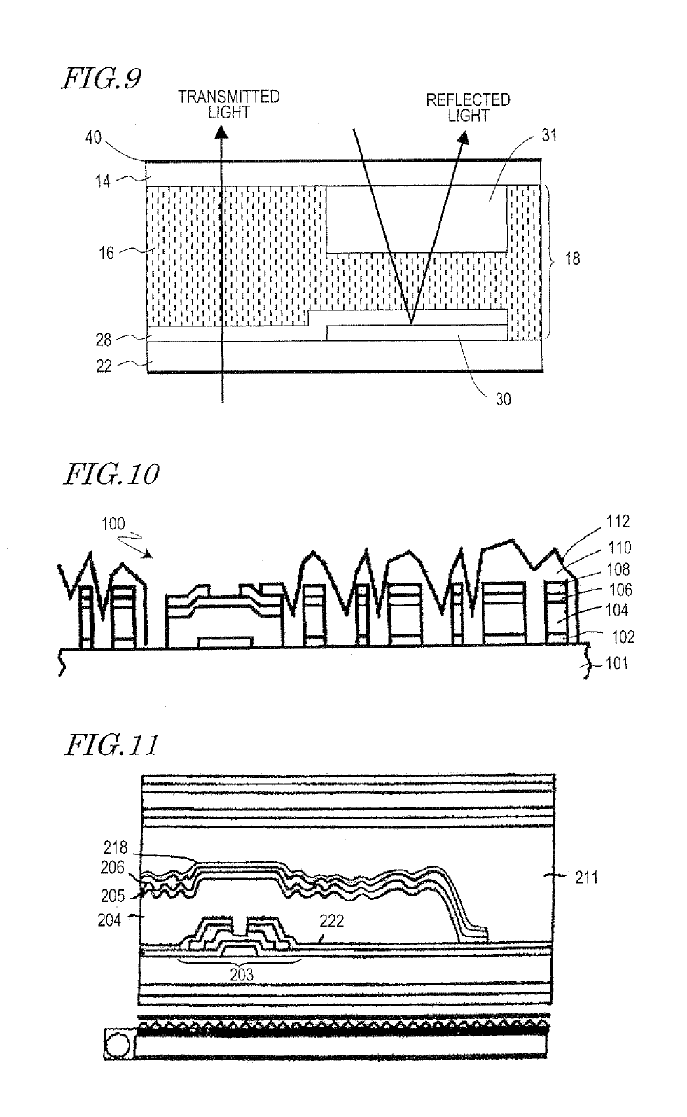

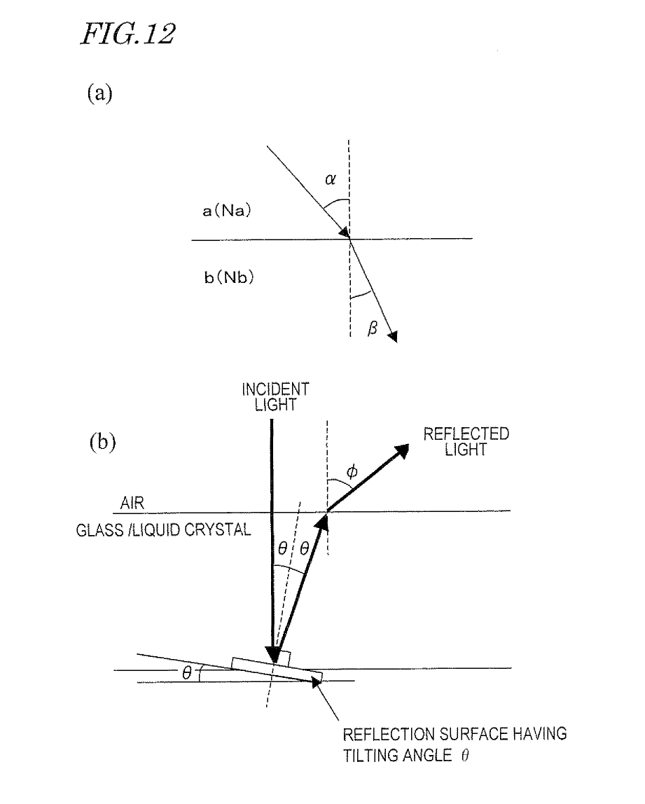

FIG. 4 is cross-sectional views for structural comparison between the reflection section 30 of Embodiment 1 and the reflection section of the conventional liquid crystal display device shown in FIG. 10. FIG. 4(a) schematically shows the structure of the reflection section 30 of Embodiment 1, and FIG. 4(b) schematically shows the structure of the reflection section of the conventional liquid crystal display device. Note that, in these figures, for simplicity, the slopes of each layer of the reflection section 30 and the slopes of each layer of the conventional liquid crystal display device are illustrated as vertical planes, and the corner portions of each level difference (portions shown by dotted circles in the figure) are illustrated as making perpendicular turns.

As shown in these figures, on the surface of the reflective layer 63 in the reflection section 30 of Embodiment 1, a total of eight corner portions are formed by one recess 68 and one protrusion 67. On the other hand, in the conventional liquid crystal display device, only four corner portions are formed in one recess of the reflection section.

Although these corner portions are illustrated as being perpendicular in FIG. 4, in an actual corner portion, as shown in FIG. 4(c), a face having angles which are larger than 20 degrees (exemplified as 30 degrees in this figure) with respect to the substrate is continuously formed from a plane (with an angle of 0 degrees) which is parallel to the substrate. Therefore, by forming more recesses in the reflection section, it becomes possible to form more faces (effective reflection surfaces) whose angle with respect to the substrate is 20 degrees or less on the surface of the reflective layer.

Moreover, since the effective reflection surfaces that are formed in a corner portion have various tilting angles which are different from one another, the reflected light will not travel in one fixed direction. Therefore, by forming more recesses, it becomes possible to obtain more reflected light which spans a broad range. Moreover, by increasing the number of recesses and ensuring that the tilting angle of the side face of any recess is 20 degrees or less, more reflected light which spans an even broader range can be obtained.

As shown in FIGS. 4(a) and (b), more recesses and protrusions than in the conventional liquid crystal display device are formed in the reflection section 30 of Embodiment 1. Since more corner portions are therefore formed, it is possible to form more effective reflection surfaces on the surface of the reflective layer 63, whereby more light can be reflected toward the display surface across a broad range. Moreover, the recess 68 and the protrusion 67 are formed in accordance with the shapes to which the Cs metal layer 56 and the semiconductor layer 62 are shaped. Therefore, the shapes, depths, and the slope tilting angles of the recess and protrusion can be easily adjusted during the shaping of the Cs metal layer 56 and the semiconductor layer 62.

Moreover, the reflective layer 63 which is located inside the recess 68 in Embodiment 1 is formed above the gate insulating layer 61, or above the gate insulating layer 61 and the semiconductor layer 62. On the other hand, in the conventional liquid crystal display device, the reflective layer inside the recess is directly formed on the glass substrate, via neither the gate insulating layer nor the semiconductor layer. Therefore, the bottom face of the recess 68 of Embodiment 1 is formed so as to be shallower than the bottom face of a recess of the conventional liquid crystal display device. As a result, incident light can be reflected more effectively across a broad range.

In the conventional liquid crystal display device, the bottom face of a recess is formed at a deep position, so that the tilting angle of the recess inner surface is large, which makes it difficult to form a large number of effective reflection surfaces having a tilt of 20 degrees or less within the recess. Moreover, since this recess is formed by forming the gate layer 102, the gate insulating layer 104, and the semiconductor layer 106, and thereafter altogether removing these layers, it has been difficult to increase the effective reflection surface by controlling the tilting angle of the recess inner surface.

Moreover, in the display device of the present embodiment, a recess 68 and a protrusion 67 are formed in accordance with the shapes of the Cs metal layer 56 and the semiconductor layer 62, and therefore the position, size, and shape of the recess 68 and the protrusion 67 can be adjusted when stacking these layers. As a result, the tilt of the slopes of the recess 68 and the protrusion 67 can be controlled, whereby a larger number of effective reflection surfaces with a tilt or 20 degrees or less can be formed, thus allowing more light to be reflected toward the display surface.

Furthermore, in the liquid crystal display device of the present embodiment, as shown in FIG. 1, the faces of the interlayer insulating layer 26 and the pixel electrode 28 that are on the liquid crystal layer 18 side are formed flat without conforming to the shapes of the recesses 68 and the protrusions 67 of the reflective layer 63, similarly to the face of the counter electrode 34 that is on the liquid crystal layer 18 side. Therefore, as compared to the conventional transflective-type liquid crystal display device shown in FIG. 11, the electric field which is formed across the liquid crystal layer 18 becomes uniform, thus making it possible to uniformly control the orientation of the liquid crystal of the reflection region 42 in a desired direction.

Moreover, since no level differences are formed in the pixel electrode 28 near the ends of the reflection section 30, the liquid crystal orientation is not disturbed. As a result, according to the present embodiment, a liquid crystal display device can be provided which has a high transmittance and excellent viewing angle characteristics, with little display unevenness.

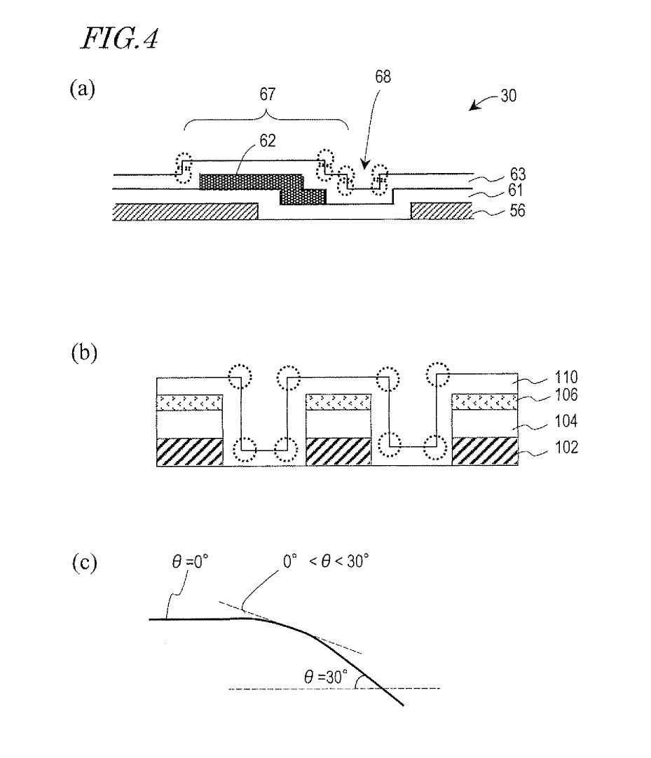

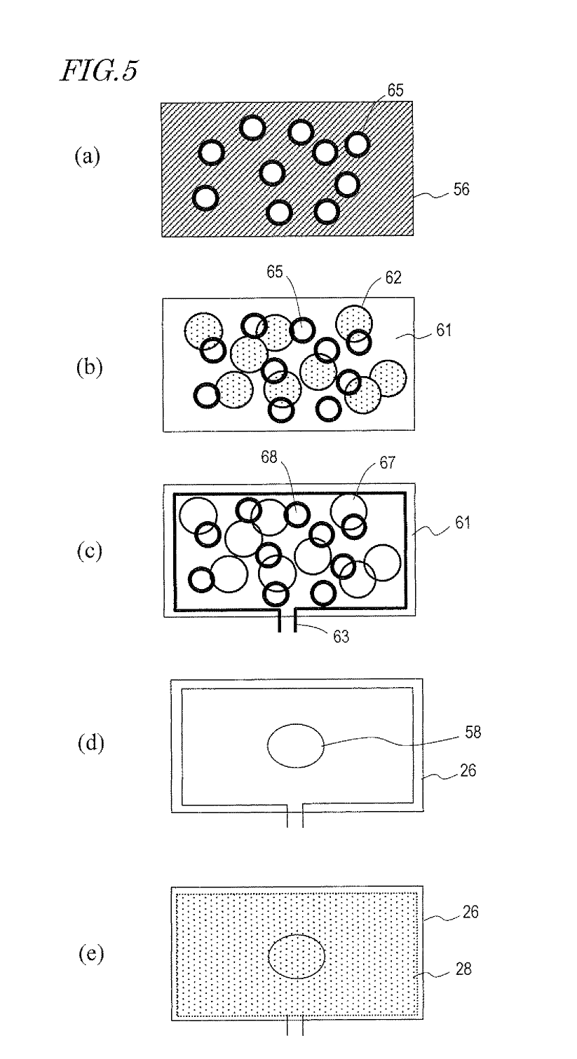

Next, a production method for the TFT substrate 12 will be described with reference to FIG. 5 and FIG. 6. FIG. 5 is plan views showing a production process, in the reflection region 42, for the TFT substrate 12; and FIG. 6 is cross-sectional views showing a production process, in the reflection region 42, for the TFT substrate 12 (a portion shown at arrow B in FIG. 2(b)).

As shown in FIG. 5(a) and FIG. 6(a), first, by a method such as sputtering, a thin metal film of Al (aluminum) is formed on the transparent substrate 22 having been cleaned. Other than Al, this thin metal film may be formed by using Ti (titanium), Cr (chromium), Mo (molybdenum), Ta (tantalum), W (tungsten), or an alloy thereof, etc., or formed from a multilayer body of a layer of such materials and a nitride film.

Thereafter, a resist film is formed on the thin metal film, and after forming a resist pattern through an exposure-development step, a dry or wet etching is performed to form the Cs metal layer (metal layer) 56 having the apertures 65. The thickness of the Cs metal layer 56 is 50 to 1000 nm, for example. Note that, although the apertures 65 are illustrated as being formed in the Cs metal layer 56, a projecting shape of Cs metal layer 56 (or an island-shaped layer) may be formed at the position of each aperture, by using a resist pattern in which the light shielding portions and the transmitting portions are inverted. In this step, the gate line (gate metal layer) 54 shown in FIG. 2(a) and the gate metal layer 54 of the TFT section 32 shown in FIG. 3(a) are also formed concurrently from the same metal.

Next, as shown in FIG. 5(b) and FIG. 6(b), by using P-CVD technique and a gaseous mixture of SiH₄, NH₃, and N₂, the gate insulating layer 61 composed of SiN (silicon nitride) is formed across the entire substrate surface. The gate insulating layer 61 may also be composed of SiO₂ (silicon oxide), Ta₂O₅ (tantalum oxide), Al₂O₃ (aluminum oxide), or the like. The thickness of the gate insulating layer 61 is 100 to 600 nm, for example. In this step, the gate insulating layer 61 of the TFT section 32 shown in FIG. 3(b) is also formed concurrently.

Next, on the gate insulating layer 61, an amorphous silicon (a-Si) film and an n⁺a-Si film obtained by doping amorphous silicon with phosphorus (P) are formed. The thickness of the a-Si film is 30 to 300 nm. The thickness of the n⁺a-Si film is 20 to 100 nm. Thereafter, these films are shaped by photolithography technique, whereby the semiconductor layer 62 is formed in island shapes. Recess (dents) or apertures may be formed in the semiconductor layer 62 by using a resist pattern in which the light shielding portions and the transmitting portions are inverted. In this step, the semiconductor layer 62 of the TFT section 32 shown in FIG. 3(b) is also formed concurrently.

Next, as shown in FIG. 5(c) and FIG. 6(c), a thin metal film of Al or the like is formed across the entire substrate surface by sputtering technique or the like, thus forming the reflective layer 63. For the thin metal film, the materials which are mentioned above as materials for the Cs metal layer 56 may be used. The thickness of the reflective layer 63 is 30 to 1000 nm or less.

At this time, the recess 68 is formed on the surface of the reflective layer 63 above each aperture 65 in the Cs metal layer 56, and the protrusion 67 is formed on the surface of the reflective layer 63 above the semiconductor layer 62. In this step, the reflective layer 63 of the TFT section 32 shown in FIG. 3(b) is also formed concurrently, and in the TFT section 32, the reflective layer 63 forms a source electrode and a drain electrode of the TFT. Also at this time, the source line 52 in FIG. 2(a) is also formed as a portion of the reflective layer 63.

Next, as shown in FIG. 5(d) and FIG. 6(d), a photosensitive acrylic resin is applied by spin-coating, whereby the interlayer insulating layer (interlayer resin layer) 26 is formed. The thickness of the interlayer insulating layer 26 is 0.3 to 5 μm. Although a thin film such as SiNₓ or SiO₂ may be formed by P-CVD technique as a protection film between the reflective layer 63 and the interlayer insulating layer 26, such is omitted from the figure. The thickness of the protection film is 50 to 1000 nm. The interlayer insulating layer 26 and the protection film are formed not only on the reflection region 42, but also on the entire upper surface of the transparent substrate including the TFT region 44. Thereafter, through a development process using an exposure apparatus, a contact hole 58 is formed near the center of the reflection section 30.

Next, as shown in FIG. 5(e) and FIG. 6(e), a transparent electrode film of ITO, IZO, or the like is formed on the interlayer insulating layer 26 by sputtering technique or the like, and this transparent electrode film is subjected to pattern shaping by photolithography technique, whereby the pixel electrode 28 is formed. The pixel electrode 28 is formed not only on the reflection region 42 but also on the entire upper surface of the pixel including the TFT region 44.

In the reflection region 42, the pixel electrode 28 is formed above the interlayer insulating layer 26 and the contact hole 58, such that the metal member of the pixel electrode 28 is in contact with the reflective layer 63 via the contact hole 58. As a result, the drain electrode of the TFT in the TFT section 32 is electrically connected to the pixel electrode 28 via the contact hole 58. In the above step, the upper face of the interlayer insulating layer 26 and the surface of the pixel electrode 28 are formed fiat without conforming to the shapes of the recesses 68 and the protrusions 67 of the reflective layer 63.

Preferably, as many recesses 68 and protrusions 67 as possible are formed on the reflective layer 63. Therefore, it is preferable that as many apertures in the Cs metal layer 56 and island shapes of semiconductor layer 62 as possible are formed on the reflection surface, within the limitations of the masks and photoexposure during the production step. The preferable maximum width of each aperture in the Cs metal layer 56 and the semiconductor layer 62 is 2 to 17 μm.

According to the present embodiment, it is possible to provide a liquid crystal display device which is capable of performing high-quality displaying with a high luminance, in which reflected light is efficiently utilized and moiré and coloration due to interference of reflected light is reduced.

### Embodiment 2

Hereinafter, a second embodiment of the liquid crystal display device according to the present invention will be described. Constituent elements which are identical to the constituent elements of Embodiment 1 are denoted by like reference numerals, and the descriptions thereof are omitted.

The liquid crystal display device of the present embodiment basically has the same construction as that of the liquid crystal display device 10 of Embodiment 1 described above, except only for the layout of the recesses 68 and the protrusions 67 which are formed on the reflection section 30. Therefore, the layout of the recesses 68 and the protrusions will be mainly described below, while omitting the descriptions of any other portions.

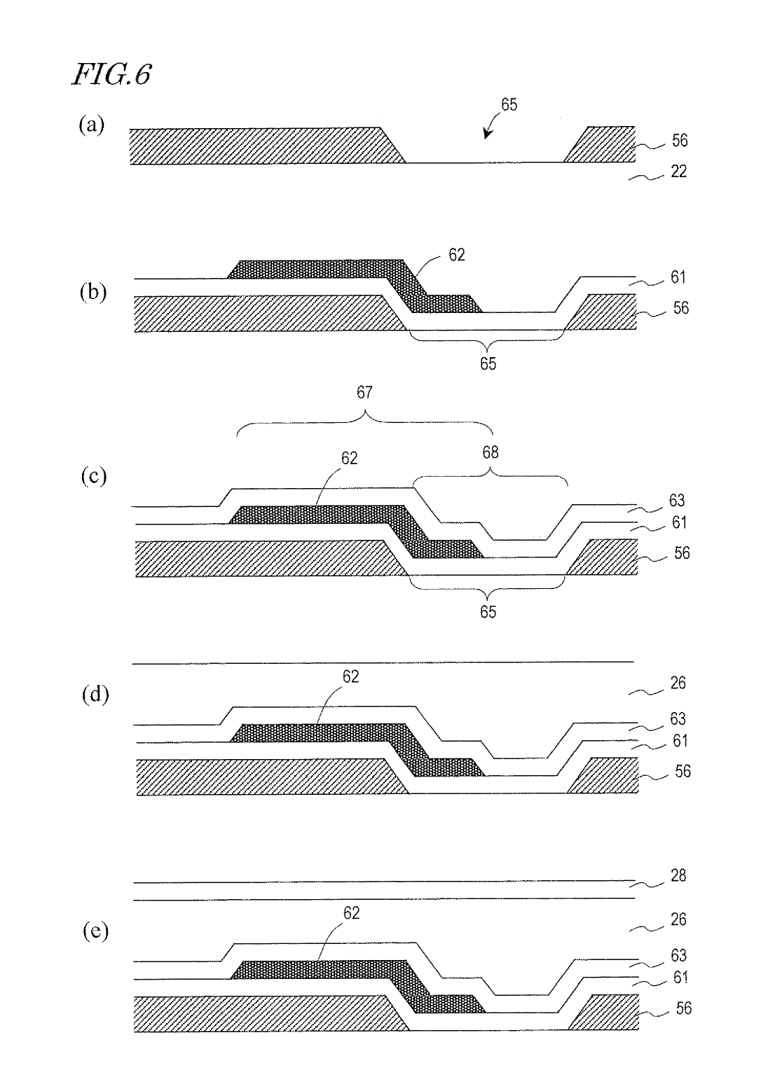

FIG. 7 is a plan view schematically showing the reflection section 30 of the liquid crystal display device according to Embodiment 2, which corresponds to FIG. 2(b) showing the reflection section 30 of Embodiment 1. On the surface of the reflective layer 63 in the reflection section 30, as shown in the figure, a plurality of protrusions 67 and recesses 68 are formed. Similarly to Example 1, the Cs metal layer 56 may be formed in island shapes, and protrusions may be formed so as to conform to their shapes, instead of apertures (or recesses) 65. Apertures (or recesses) may be formed in the semiconductor layer 62, and recesses may be formed so as to conform to their shapes, instead of protrusions 67.

As shown in the figure, recesses 68 (or first recesses or protrusions) are disposed at equal intervals along the vertical direction and along the lateral direction, whereas the protrusions 67 (or second recesses or protrusions) are randomly disposed similarly to Embodiment 1. Note that the protrusions 67 do not need to be perfectly randomly disposed, but may be randomly disposed in portions of the surface of the reflective layer 63. Moreover, a layout lacking symmetry or an anisotropic layout may be adopted.

In either case, a plurality of pairs (second pairs) of protrusions 67 adjoining along a direction (second direction) include two pairs whose intervals between protrusions 67 are different from each other. Moreover, a plurality of pairs (fourth pairs) of protrusions 67 adjoining along a direction (fourth direction) which is different from the second direction may include two pairs whose intervals between protrusions 67 are different from each other. With such layout methods, it becomes possible to reduce occurrence of moiré or coloration due to interference of reflected light.

### Embodiment 3

Hereinafter, a third embodiment of the liquid crystal display device according to the present invention will be described. Constituent elements which are identical to the constituent elements of Embodiment 1 are denoted by like reference numerals, and the descriptions thereof are omitted.

The liquid crystal display device of the present embodiment basically has the same construction as that of the liquid crystal display device 10 of Embodiment 1 described above, except only for the layout of the recesses 68 and the protrusions 67 which are formed on the reflection section 30. Therefore, the layout of the recesses 68 and the protrusions will be mainly described below, while omitting the descriptions of any other portions.

FIG. 8 is a plan view schematically showing the reflection section 30 of the liquid crystal display device of Embodiment 3, which corresponds to FIG. 2(b) showing the reflection section 30 of Embodiment 1. On the surface of the reflective layer 63 in the reflection section 30, as shown in the figure, a plurality of protrusions 67 and recesses 68 are formed. Similarly to Example 1, the Cs metal layer 56 may be formed in island shapes, and protrusions may be formed so as to conform to their shapes, instead of apertures (or recesses) 65. Aperture (or recesses) may be formed in the semiconductor layer 62, and recesses may be formed so as to conform to their shapes, instead of protrusions 67.

As shown in the figure, the recesses 68 (or first recesses or protrusions) are randomly disposed similarly to Embodiment 1, whereas the protrusions 67 (or second recesses or protrusions) are disposed at equal intervals along the vertical direction and along the lateral direction. Note that the recesses 68 do not need to be perfectly randomly disposed, but may be randomly disposed in portions of the surface of the reflective layer 63. Moreover, a layout lacking symmetry or an anisotropic layout may be adopted.

In either case, a plurality of pairs (first pairs) of recesses 68 adjoining along a direction (first direction) include two pairs whose intervals between recesses 68 are different from each other. Moreover, a plurality of pairs (third pairs) of recesses 68 adjoining along a direction (third direction) which is different from the first direction may include two pairs whose intervals between recesses 68 are different from each other. With such layout methods, it becomes possible to reduce occurrence of moiré or coloration due to interference of reflected light.

### Embodiment 4

Hereinafter, with reference to the drawings, a fourth embodiment of the liquid crystal display device according to the present invention will be described. Constituent elements which are identical to the constituent elements of Embodiments 1 to 3 are denoted by like reference numerals, and the descriptions thereof are omitted.

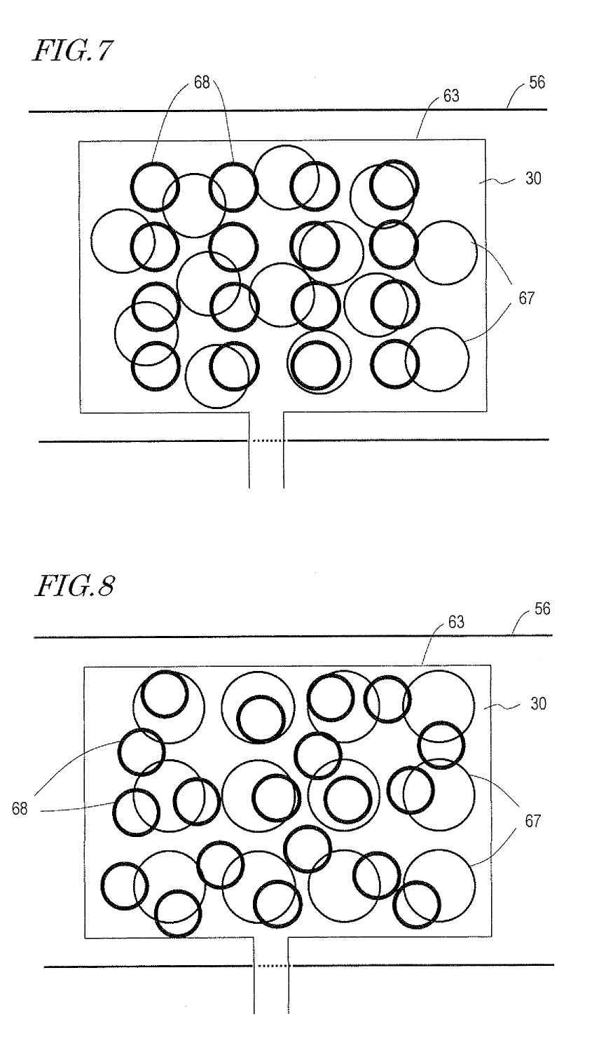

FIG. 9 is a diagram schematically showing a cross-sectional shape of the liquid crystal display device of the present embodiment. This liquid crystal display device is based on the liquid crystal display devices of Embodiments 1 to 3 from which the interlayer insulating layer 26 is excluded, and is identical to the liquid crystal display devices of Embodiments 1 to 3 except for the points discussed below. Note that, in FIG. 9, the detailed structure of the counter substrate 14 and the TFT section 32 are omitted from illustration.

As shown in the figure, in Embodiment 4, no interlayer insulating layer 26 is formed, and therefore the pixel electrode 28 is formed upon the reflective layer 63 in the reflection section 30 and the TFT section 32, via an insulative film not shown. The structure and production method for the reflection section 30 and the TFT section 32 are the same as those which were described in Embodiment 1 except that the interlayer insulating layer 26 is eliminated. The pixel layout and wiring structure in the display device are also similar to what is shown in FIG. 2(a). Also with this construction, similarly to Embodiments 1 to 3, the effective reflection surface of the reflective layer 63 is expanded in area, so that more light can be reflected toward the display surface.

Embodiments 1 to 4 illustrate that the apertures 65 in the Cs metal layer 56, the semiconductor layer 62, the protrusions 67, and the recesses 68 are circular, but they may be formed into ellipses, polygons such as triangles or rectangles, or formed into various shapes such as recesses or protrusions with sawtoothed edges, or combinations thereof.

As has been illustrated by the above Embodiments, a liquid crystal display device according to the present invention includes a large number of level differences and corner portions on the surface of a reflective layer, as well as a large number of slopes with a tilting angle of 20 degrees or less, and therefore acquires reflection regions with broad effective reflection surfaces and excellent scattering characteristics. Moreover, since the shape of the reflective layer surface is not likely to have symmetry, occurrence of moiré and coloration due to interference of reflected light can be reduced or prevented. Thus, a liquid crystal display device having a high brightness and being capable of clear displaying can be provided.

Moreover, since the level differences and corner portions on the reflection surface are formed in accordance with the shapes of the Cs metal layer and the semiconductor layer just when they are shaped, reflection regions having excellent reflection characteristics can be easily obtained without increasing the production steps. Furthermore, since the liquid crystal display device according to the present invention is formed by the above-described production method, it can be produced with the same material and the same steps as those of a transmission-type liquid crystal display device. Therefore, a high-quality liquid crystal display device can be provided inexpensively.

Furthermore, according to the present invention, the face of a pixel electrode facing the liquid crystal layer is formed flat, similarly to its face on the counter electrode side, and no level difference is formed in the pixel electrode near the end of the reflection section, thus making it possible to uniformly control the orientation of liquid crystal in a desired direction. Therefore, it is possible to provide a liquid crystal display device which has a high transmittance, excellent viewing angle characteristics, and little display unevenness.

The liquid crystal display device according to the present invention encompasses display apparatuses, television sets, mobile phones, etc., in which a liquid crystal panel is utilized. Although the present embodiment employs a transflective-type liquid crystal display device as an example, a reflection-type liquid crystal display device or the like having a configuration similar to the aforementioned reflection section is also encompassed as an embodiment of the present invention.

### INDUSTRIAL APPLICABILITY

According to the present invention, a transflective-type liquid crystal display device and a reflection-type liquid crystal display device having a high image quality can be provide inexpensively. Liquid crystal display devices according to present invention are suitably used for various liquid crystal display devices, and are suitably used for transflective-type and reflection-type liquid crystal display devices which perform display by utilizing reflected light, e.g., mobile phones, onboard display devices such as car navigation systems, display devices of ATMs and vending machines, etc., portable display devices, laptop PCs, and the like.

1. A liquid crystal display device having a plurality of pixels, and comprising, in each of the plurality of pixels, a reflection region for reflecting incident light toward a display surface, wherein,
the reflection region includes a metal layer, a semiconductor layer formed on the metal layer, and a reflective layer formed on the semiconductor layer;
a plurality of first recesses or protrusions and a plurality of second recesses or protrusions are formed on a surface of the reflective layer;
the plurality of first recesses or protrusions are formed so as to conform to the shapes of recesses or protrusions of the metal layer, and the plurality of second recesses or protrusions are formed so as to conform to the shapes of recesses or protrusions of the semiconductor layer; and
the plurality of first recesses or protrusions have a plurality of first pairs of first recesses or protrusions adjoining along a first direction, the plurality of first pairs including two pairs whose intervals between recesses or protrusions are different from each other, or
the plurality of second recesses or protrusions have a plurality of second pairs of second recesses or protrusions adjoining along a second direction, the plurality of second pairs including two pairs whose intervals between recesses or protrusions are different from each other.

2. The liquid crystal display device of claim 1, wherein the plurality of first recesses or protrusions have a plurality of third pairs of first recesses or protrusions adjoining along a third direction which is different from the first direction, and the plurality of third pairs include two pairs whose intervals between recesses or protrusions are different from each other.

3. The liquid crystal display device of claim 1, wherein the plurality of second recesses or protrusions have a plurality of fourth pairs of second recesses or protrusions adjoining along a fourth direction which is different from the second direction, and the plurality of fourth pairs include two pairs whose intervals between recesses or protrusions are different from each other.

4. The liquid crystal display device of claim 1, wherein,
the plurality of first recesses or protrusions have a plurality of third pairs of first recesses or protrusions adjoining along a third direction which is different from the first direction, and the plurality of third pairs include two pairs whose intervals between recesses or protrusions are different from each other; and
the plurality of second recesses or protrusions have a plurality of fourth pairs of second recesses or protrusions adjoining along a fourth direction which is different from the second direction, and the plurality of fourth pairs include two pairs whose intervals between recesses or protrusions are different from each other.

5. The liquid crystal display device of claim 1, wherein, on the surface of the reflective layer, at least either the plurality of first recesses or protrusions or the plurality of second recesses or protrusions are randomly disposed.

6. The liquid crystal display device of claim 5, wherein, on the surface of the reflective layer, both the plurality of first recesses or protrusions and the plurality of second recesses or protrusions are randomly disposed.

7. The liquid crystal display device of claim 1, comprising a semiconductor element provided corresponding to each of the plurality of pixels, wherein,
the metal layer, the semiconductor layer, and the reflective layer are made of same materials as those of a gate electrode, a semiconductor portion, and source and drain electrodes of the semiconductor element, respectively.

8. The liquid crystal display device of claim 1, comprising a liquid crystal layer and an interlayer insulating layer and a pixel electrode interposed between the liquid crystal layer and the reflective layer, wherein a surface of the pixel electrode facing the liquid crystal layer is formed flat without conforming to shapes of the first recesses or protrusions and the second recesses or protrusions of the reflective layer.
